(19) United States
(12) Patent Application Publication
(10) Pub. No.: US 2020/0174444 A1
(43) Pub. Date: Jun. 4, 2020

(54) ASSEMBLY LINE TOOL TEST CARRIER AND METHOD OF USING

(71) Applicant: Lear Corporation, Southfield, MI (US)

(72) Inventor: Larry Bruck, Howell, MI (US)

(73) Assignee: Lear Corporation, Southfield, MI (US)

(21) Appl. No.: 16/205,325

(22) Filed: Nov. 30, 2018

(51) Int. Cl. G05B 19/402; G05B 19/401

(52) U.S. Cl. CPC G05B 19/402; G05B 2219/35313; G05B 19/401

(57) ABSTRACT

A test carrier for use on an assembly line includes a pallet that is adapted to be input into an assembly line. The pallet is adapted to move sequentially through a plurality of workstations on the assembly line. The test pallet includes a validation device supported on the pallet. The validation device is adapted to be operated on by at least one of a plurality of tools on the assembly line to produce a validation result.

### BACKGROUND OF THE INVENTION

This invention relates to a system for validating tools utilized on an assembly line. More specifically, this invention relates to a system for the in-place validating of tools utilized on an assembly line.

In conventional manufacturing, assemblies of components are typically built using an assembly line. On the assembly line, an unfinished assembly is moved sequentially through multiple workstations. At each workstation, additional components are added to the unfinished assembly or different processes are performed on the unfinished assembly. At the end of the assembly line, a finished assembly is produced. The finished assembly may be a completed product or may require additional manufacturing steps before it is a completed product.

At each workstation, there may be various tools used to position the components and attach them to the unfinished assembly or to conduct processes on the unfinished assembly. This can include processes such as tightening screws and bolts, fastening rivets, cutting, drilling holes, or performing various types welding. The types of processes performed on the assembly line will depend on the details of the finished assembly being produced. The types of tools used to perform each of the processes will also vary. These tools may be operated manually or robotically.

In some instances, the tools may be required to meet particular specifications. This could be required by a customer or by a regulator, for example, with specifications directed toward particular tolerances, dimensions, or strength of the finished assembly. In order to meet these specifications, the conventional assembly line can include test mechanisms that are used on at least a sample of the unfinished assemblies or the finished assemblies. The test mechanisms can test features such as the strength of locks, the resistance to movement offered by joints, the accuracy of sensors in the finished assembly, or any other features or characteristics.

In order to ensure that each of the finished assemblies produced by the assembly line meets the desired specifications, the tools and the test mechanisms can be tested and calibrated. The particular tests and calibration will depend on the particular tools used and typically involve removing the tools from the assembly line and taking them to a remote location for testing. It would be advantageous to have an improved method to ensure that the tools on an assembly line are operating to specification.

### SUMMARY OF THE INVENTION

The invention relates to a test carrier for use on an assembly line. The test carrier includes a pallet that is adapted to be input into an assembly line. The test pallet is adapted to move sequentially through a plurality of workstations on the assembly line. The test pallet includes a validation device supported on the pallet. The validation device is adapted to be operated on by at least one of a plurality of tools on the assembly line to produce a validation result.

The invention also relates to a method for validating tools on an assembly line. The system includes inputting a test carrier into an assembly line. The assembly line includes a plurality of workstations. The test carrier advances through the workstations in sequence. The system includes operating one of a plurality tools on a validation device on the test carrier. The system also includes producing a validation result that represents an output of the validation device.

The invention also relates to a method of validating tools on an assembly line. The method includes inputting a sequence of carriers into an assembly line. The assembly line includes a plurality of workstations, and sequential assembly operations are performed on the carriers to produce a finished assembly. The assembly line includes a plurality of assembly tools. The method includes including a test carrier in the sequence of carriers. The test carrier moves sequentially through the plurality of workstations. The method also includes operating at least one of the plurality of assembly tools on a validation device on the test carrier to produce a validation result.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a schematic view of an assembly line.

FIG. 2 is a schematic view of a sequence of carriers for use in the assembly line shown in FIG. 1.

FIG. 3 is a perspective view of a first embodiment of a test carrier.

FIG. 4 is a perspective view of a second embodiment of a test carrier.

FIG. 5 is a schematic view of the assembly line and the sequence of carriers.

FIG. 6 is a schematic view of a log including validation results.

### DETAILED DESCRIPTION OF THE PREFERRED EMBODIMENTS

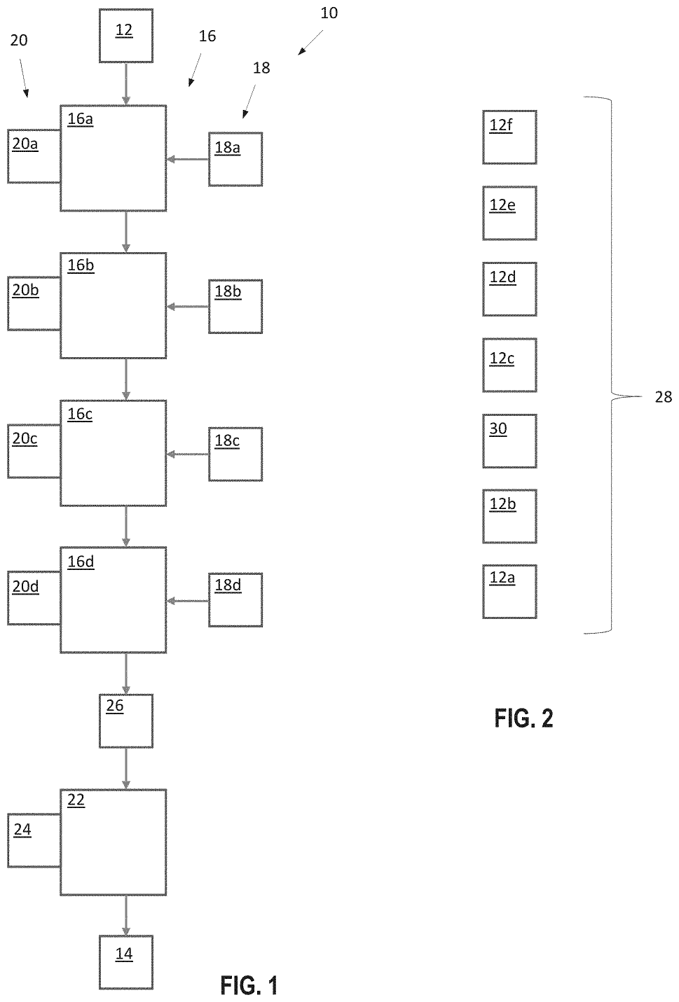

Referring now to the drawings, there is illustrated in FIG. 1 a schematic view of an assembly line, indicated generally at 10. The assembly line 10 uses a sequential assembly process, wherein a carrier 12 is input into the assembly line 10, and a finished assembly 14 is assembled. The carrier 12 is a support on which the sequential assembly process take place. The carrier 12 may include partial components of the finished assembly 14. The finished assembly 14 may be a complete product, or the finished assembly 14 may require additional assembly in order to provide a complete product.

The assembly line 10 includes a plurality of workstations, indicated generally at 16. The illustrated assembly line 10 include four workstations 16a-16d, which are provided for illustrative purposes only and the assembly line 10 may include any desired number of workstations 16. At each workstation 16, inputs, indicated generally at 18, are provided. The inputs 18 include desired parts that are added to the carrier 12 to produce the finished assembly 14. The illustrated assembly line 10 includes four inputs 18a-18d, one at each of the workstations 16a-16d. However, the assembly line may include any desired number of inputs 18. The assembly line 10 includes a plurality of assembly tools 20. The assembly tools 20 are used at the workstations 16 to conduct the assembly of the finished assembly 14. The illustrated assembly line 10 includes four assembly tools 20a-20d, one at each of the workstations 16a-16d. However, the assembly line 10 may include any desired number of assembly tools 20. The assembly tools 20 may be operated manually or robotically.

The assembly line 10 also includes a test station 22. The test station 22 includes test tools 24 that are used to test desired features of a pre-test assembly 26. The test tools 24 may be any desired tools, sensors, or equipment to test any desired characteristics of the finished assembly 14. The illustrated test station 22 is located at the end of the assembly line 10, after each of the workstations 16. However, the test station 22 may be located in any desired location on the assembly line 10.

Referring to FIG. 2, there is illustrated a schematic view of a sequence of carriers, indicated generally at 28. The illustrated sequence of carriers 28 includes six carriers 12a, 12b, etc., each of which is interchangeable and adapted to be input into the assembly line 10 in place of the carrier 12. Also included in the sequence of carriers 28 is a test carrier 30. The test carrier 30 is also adapted to be input into the assembly line 10 in place of the carrier 12. In the illustrated embodiment, the test carrier 30 is inserted into the sequence of carriers 28 between the carrier 12b and the carrier 12c. However, the test carrier 30 may be inserted into the sequence of carriers 28 at any desired location.

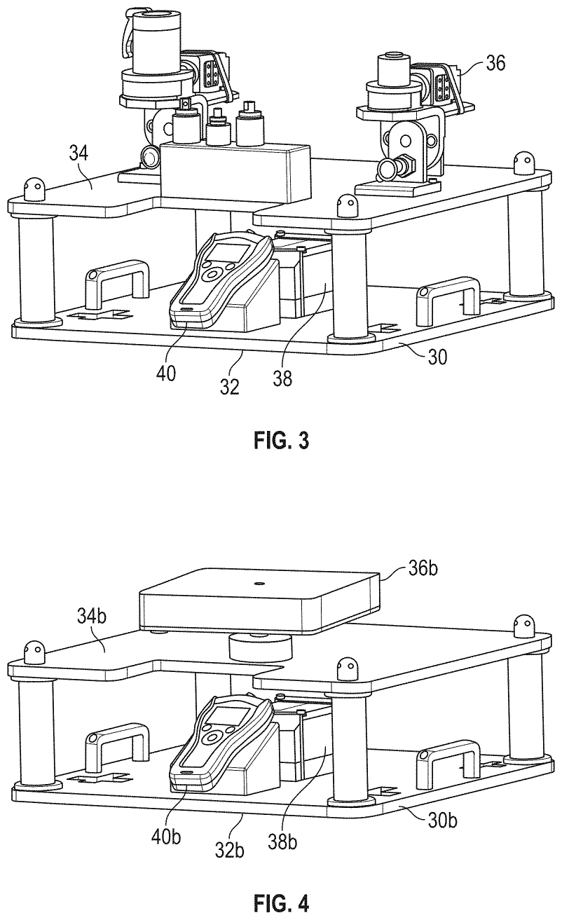

Referring to FIG. 3, there is illustrated a perspective view of a first embodiment of the test carrier 30. The test carrier 30 includes a pallet 32 which serves as a base for the other components of the test carrier 30. The illustrated pallet 32 is made of steel and has a rectangular shape. However, the pallet 32 may be made of any desired material and have any desired shape. The pallet 32 is dimensioned so that it may be moved between the workstations 16 of the assembly line 10 similarly to the carrier 12 and is adapted to be input into the assembly line 10 and move sequentially through the workstations 16. The test carrier 30 includes a frame 34 that is attached to the pallet 32. The illustrated frame 34 is made of aluminum but may be made of any desired material. The test carrier 30 includes a validation device 36 that is supported on the frame 34. The validation device 36 may be used at one or more of the workstations 16 to test one or more of the assembly tools 20 to determine if the assembly tool 20 is operating to a desired specification.

In the illustrated embodiment, the validation device 36 includes a torque transducer. However, the validation device 36 may include any type of testing, calibration, gauge measurement, or any other desired devices. The particular validation device 36 desired for use on the assembly line 10 will depend on the specific assembly tools 20 and test tools 24 that are included on the assembly line 10.

The test carrier 30 also includes a computer 38 and an input-output device 40. The computer 38 is used to record data regarding the operation of the validation device 36 and its use on the assembly tools 20. The input-output device 40 allows an operator to interact with the computer 38.

Referring to FIG. 4, there is illustrated a perspective view of a second test carrier 30b. The second test carrier 30b includes many features similar to the test carrier 30. These features are identified by the same element number with the suffix “b” and will not be described in detail. The second test carrier 30b includes a second validation device 36b that is used to test the proper operation of the test tools 24. In the illustrated embodiment, the second validation device 36b is a scale that is used to test a weight applied to the pre-test assembly 26 at the test station 22. However, the second validation device 36b may include any type of testing, calibration, gauge measurement, or any other desired devices.

Although the illustrated embodiment shows the validation device 36 and the second validation device 36b on the separate test carriers 30 and 30b, the validation device 36 and the second validation device 36b may both be included on a single test carrier 30, if desired.

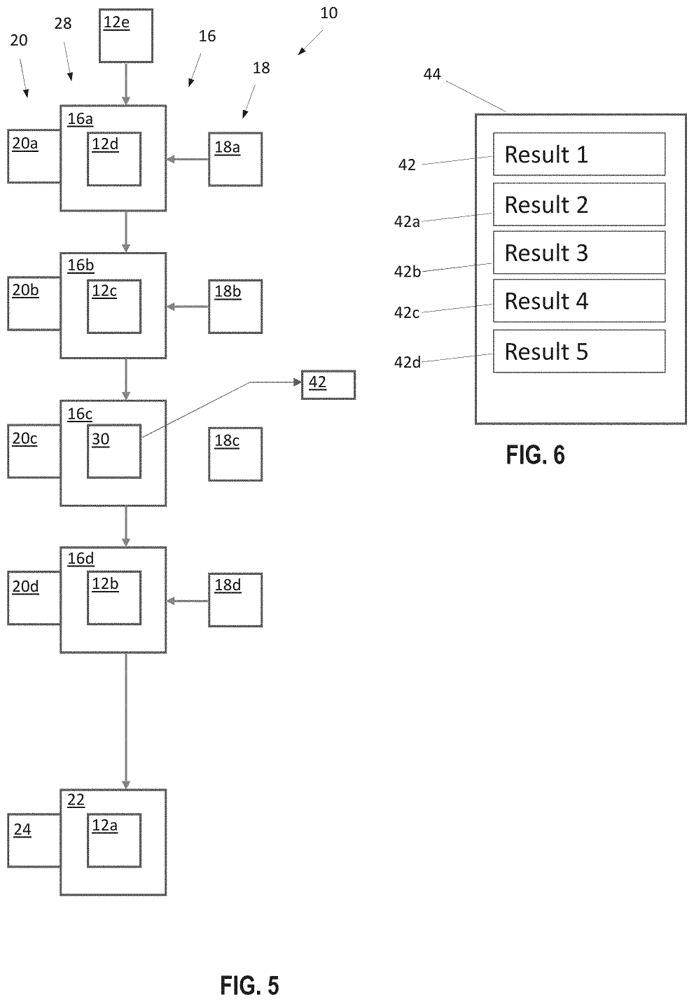

Referring to FIG. 5, there is illustrated a schematic view of the assembly line 10 and the sequence of carriers 28. Each of the carriers 12a, 12b, etc. and the test carrier 30 are located at respective ones of the workstations 16. FIG. 5 illustrates one step in the sequential assembly process on the assembly line 10. As shown, the carrier 12a is located in the test station 22, where it is subject to testing by operation of the test tools 24. The carrier 12b is located in the workstation 16d, where the assembly tools 20d are used to attach the inputs 18d.

At the step shown, the test carrier 30 is located in the workstation 16c. The test carrier 30 progresses through the workstations 16 similarly to the carrier 12a, but the inputs 18 are not attached to the test carrier 30. Thus, when the test carrier 30 is located in the workstation 16c, the inputs 18c are not used during this step of the assembly sequence. When the test carrier 30 is located in the workstation 16c, the assembly tools 20c are operated on the validation device 36 on the test carrier 30. The input-output device 40 may be used by the operator to identify which of the assembly tools 20 is being operated on the validation device 36. In the illustrated embodiment, the assembly tools 20c include a torque wrench. The torque wrench is operated on the torque transducer, and the computer 38 is used to monitor the operation of the validation device 36 and generate a validation result 42. The assembly tools 20c may be operated on the validation device 36 multiple times to generate multiple validation results 42, if desired. Although the illustrated embodiment includes a torque wrench and a torque transducer, the tools 20c and the validation device 36 may be any desired devices.

The validation result 42 may be used in a variety of ways, as desired. The torque generated by the torque wrench may be compared to a target value to determine if the torque wrench is operating within specification. The validation result 42 may be one of “pass” and “fail.” The validation result 42 may be recorded in a log 44, shown in FIG. 6. The log 44 includes additional validation results 42a, 42b, etc. that are recorded at different times. This allows the performance of the assembly tool 20c to be monitored over time so that the assembly tool 20c may receive calibration, maintenance, or replacement before it is operating out of specification.

After the step illustrated in FIG. 5, the test carrier 30 will advance on the assembly line 10 to the workstation 16d, where the assembly tools 20c may be operated on the validation device 36. The test carrier 30 may include additional validation devices (not shown) that allow different types of assembly tools 20 and test tools 24 to be operated to generate additional validation results. Additionally, both the test carrier 30 and the second test carrier 30b may be included in the sequence of carriers 28 in order to allow different of the assembly tools 20 and test tools 24 to be operated on the validation device 36 and the second validation device 36b.

Referring back to FIG. 1, the quantity of finished assemblies 14 that the assembly line 10 can produce in a given time period will depend on the details of the assembly line 10. For example, the quantity of finished assemblies 14 that can be produced in one day will depend on the time required for one sequential assembly step and how long the assembly line 10 is operated each day. The sequence of carriers 28 illustrated in FIG. 2 will be input into the assembly line 10 over some period of time. The test carrier 30 may be input into the assembly line 10 at any desired frequency. For example, the test carrier 30 may be input into the assembly line 10 once every day, or once every month, or any other desired time interval. This allows the assembly tools 20 and the test tools 24 to be validated at any desired frequency.

Additionally, the test carrier 30 may be input into the assembly line 10 at times not related to the frequency but, rather, in response to some sort of event. For example, the test carrier 30 may be input into the assembly line 10 after one of the assembly tools 20 has been replaced.

Also, the test carrier 30 and the second test carrier 30b may be input into the assembly line 10 at the same frequency or at different frequencies. This allows different ones of the assembly tools 20 and the test tools 24 to be validated at different frequencies, if desired. The test carrier 30 may be used on a second assembly line (not shown) or any additional number of assembly lines, if desired. This allows the test carrier 30 to be used to validate the assembly tools 20 on multiple assembly lines.

The use of the test carrier 30 to validate the assembly tools 20 and the test tools 24 is advantageous in that it allows proper operation the assembly tools 20 and the test tools 24 to be validated without taking them out of service. This allows the assembly tools 20 and the test tools 24 to be validated at an increased frequency. One of the assembly tools 20 that is close to operating out of specification may be identified before it is operating out of specification. If one of the assembly tools 20 is identified as operating out of specification, there will be fewer finished assemblies 14 that may require repair or replacement.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A method for validating tools on an assembly line comprising the steps of:
inputting a test carrier into an assembly line, the assembly line including a plurality of workstations wherein the test carrier advances through the workstations in sequence;
operating one of a plurality tools on a validation device on the test carrier; and
producing a validation result that represents an output of the validation device.

2. The method for validating tools on an assembly line of claim 1, further comprising the steps of:
operating a second one of the plurality of tools on the validation device on the test carrier; and
producing a second validation result that represents an output of the validation device.

3. The method for validating tools on an assembly line of claim 2, further comprising the steps of:
operating a third one of the plurality of tools on a second validation device on the test carrier; and
producing a third validation result that represents an output of the second validation device.

4. The method for validating tools on an assembly line of claim 1, further comprising the steps of:
operating a second one of the plurality of tools on a second validation device on the test carrier; and
producing a second validation result that represents an output of the second validation device.

5. A method of validating tools on an assembly line comprising the steps of:
inputting a sequence of carriers into an assembly line, wherein the assembly line includes a plurality of workstations wherein sequential assembly is performed on each of the carriers to produce a finished assembly, and wherein the assembly line includes a plurality of assembly tools;
including a test carrier in the sequence of carriers, wherein the test carrier moves sequentially through the plurality of workstations; and
operating at least one of the plurality of assembly tools on a validation device on the test carrier to produce a validation result.

6. The method of validating tools on an assembly line of claim 5, further comprising the steps of:
operating a second one of the plurality of assembly tools on the validation device on the test carrier to produce a second validation result.

7. The method of validating tools on an assembly line of claim 6, further comprising the steps of:
operating a third one of the plurality of assembly tools on a second validation device on the test carrier to produce a third validation result.

8. The method of validating tools on an assembly line of claim 5, further comprising the steps of:
operating a second one of the plurality of assembly tools on a second validation device on the test carrier to produce a second validation result.

9. A test carrier for use on an assembly line, comprising:
a pallet that is adapted to be input into an assembly line and move sequentially through a plurality of workstations; and
a validation device supported on the pallet, wherein the validation device is adapted to be operated on by at least one of a plurality of tools on the assembly line to produce a validation result.

10. The test carrier for use on an assembly line of claim 9, wherein the validation device is adapted to be operated on by a second of the plurality of tools on the assembly line to produce a second validation result.

11. The test carrier for use on an assembly line of claim 10, wherein the test pallet further includes a second validation device adapted to be operated on by a third of the plurality of tools on the assembly line to produce a third validation result.

12. The test carrier for use on an assembly line of claim 9, wherein the test pallet further includes a second validation device adapted to be operated on by a second of the plurality of tools on the assembly line to produce a second validation result.
